(19) United States
(12) Patent Application Publication
(10) Pub. No.: US 2012/0153573 A1
(43) Pub. Date: Jun. 21, 2012

(54) Fluid Seal Assembly

(76) Inventors: Alfred Robert Wade, Elgin, IL (US); John Randolph Tipps, Sycamore, IL (US); Bret Thomas Dana, Harvard, IL (US)

(21) Appl. No.: 12/973,609

(22) Filed: Dec. 20, 2010

(51) Int. Cl. F16J 15/16

(52) U.S. Cl. 277/312; 277/500

(57) ABSTRACT

A fluid seal assembly (the assembly) of the present invention is disposed between an outer surface, i.e. engine block or any other part that requires application of the assembly and a rotatable member, such as, for example a shaft, wherein the assembly circumscribes the shaft and lubricated the shaft and the same rotates around the axis. The assembly includes a primary seal and a wear sleeve. The primary seal includes a casing and a seal element that contacts a sealing surface on the wear sleeve. The casing includes an outer diameter and an outer seal formed onto the outer diameter. The wear sleeve has a cylindrical portion defining an inner diameter and an inner seal formed into the inner diameter of the wear sleeve. The outer and inner seals of the present invention provide improved retention in metal bores during thermal expansion and eliminate spring back effect of the assembly after installation.

### FIELD OF THE INVENTION

The present invention relates generally to fluid seals for use with relatively rotatable members, such as shafts and the like.

### BACKGROUND OF THE INVENTION

Fluid seals assemblies of various types are used in numerous applications including and not limited to sealing vehicular engine crankshafts, transmission shafts, bearing lubrication systems, compressor shaft support assemblies, and the like. These fluid seal assemblies are designed to retain and seal oil or grease in a predetermined location for lubricating the shaft and to prevent ingress of environmental contaminants. These fluid seal assemblies are also designed for the sealing of openings between rotating and stationary component or between two components in relative motion to form a barrier to retain lubricants or liquids, exclude contaminants, separate fluids, and confine pressure. It is important to constantly retain and seal oil or grease in a predetermined location for lubrication of the shaft and to prevent ingress of environmental contaminants.

The art is replete with various prior art references related to numerous seal designed to be adaptable to retain and seal oil or grease in a predetermined location for lubrication the shaft. These prior art references include and are not limited to U.S. Pat. No. 3,856,368 to Andersen; U.S. Pat. No. 3,929,340 to Peisker; U.S. Pat. No. 4,336,945 to Christiansen, et al.; U.S. Pat. No. 4,501,431 to Peisker et al.; U.S. Pat. No. 5,350,181 to Horve, and U.S. Pat. No. 6,921,082 to Lutaud.

The U.S. Pat. No. 3,856,368 to Andersen teaches a seal assembly presenting a seal casing and a wear sleeve rigidly engaging a shaft rotatable about a housing having a bore to receive the seal casing. A seal ring is formed from a polymeric product, i.e. a rubber, and includes a molded elastomeric portion extending from the seal ring to engage the wall of the seal casing. A radially extending metallic element is connected to the seal ring to sandwich the molded elastomeric portion located between the wall of the seal casing and the radially extending metallic element.

The seal assembly taught by the U.S. Pat. No. 3,856,368 to Andersen presents a design that required multitude of parts to be engaged with one another thereby requiring additional steps in manufacturing process and extra part, which is not cost effective in mass production. In addition, the design of this seal assembly does not improve retention of the seal casing inside the housing during thermal expansion and does not eliminate spring back effect of the seal assembly as the cylindrical member rotates relative the seal casing.

Another U.S. Pat. No. 5,350,181 to Horve, for example, teaches a fluid seal assembly. The fluid seal assembly is inserted within a counterbore of a housing, which journals a rotary shaft rotatable therewithin. The assembly includes a primary seal casing and a wear sleeve. The primary seal casing includes an axially extending mounting flange and a radially extending, lip body bonding flange. The mounting flange frictionally engages the counterbore. The wear sleeve includes a radially extending excluder flange and a shaft-engaging skirt portion, frictionally engaging the rotary shaft.

The seal assembly taught by the U.S. Pat. No. 5,350,181 to Horve presents a design that eliminates problems such as, for example, necessity for multitude of parts to be engaged with one another, as in the aforementioned design taught by the U.S. Pat. No. 3,856,368 to Andersen. However, the design of the seal assembly taught by the U.S. Pat. No. 5,350,181 to Horve does not improve retention of the seal casing inside the housing during thermal expansion and does not eliminate spring back effect of the seal assembly as the cylindrical member rotates relative the seal casing.

Still another prior art application used in the seal manufacturing industry today employs a boretite coating, which contains rubberized OD bore sealant that fills small imperfections in the bore. Painted smooth surface of the coating provides 20% less frictional torque (drag) during installation resulting in power savings and a reduction of the possibility of early failure due to damage, and does not provide retention during thermal expansion.

Hence, there is a need for an improved fluid seals and methods to eliminate problems associated with prior art designs thereby improving retention of said casing unit inside the housing and on shaft during thermal expansion and eliminate spring back effect of said seal assembly as the cylindrical member rotates relative said casing unit.

There is also a need for an improved fluid seals and methods to eliminate problems associated with prior art designs such as static leakage of oil, clogging up the seals with carbonized oil, constant wear and tear and replacement of parts that negatively impact lifecycle of the fluid seals. The inventive concept as set forth further below improves the aforementioned prior art systems and methods.

### SUMMARY OF THE INVENTION

A fluid seals assembly (the assembly) of the present invention has numerous applications including and not limited to sealing vehicular engine crankshafts, transmission shafts, bearing lubrication systems, compressor shaft support assemblies, and the like. The assembly is disposed between an outer surface, i.e. a housing or an engine block or any other part that requires application of the assembly and a rotatable member, such as, for example a shaft, wherein the assembly circumscribes the shaft and lubricated the shaft as the same rotates around the axis.

The assembly includes a primary seal and a wear sleeve. The primary seal includes a casing presenting a side wall and a flange extending from the side wall. A step or groove is defined in the outer surface of the side wall. A first seal element formed from a liquid ultraviolet (UV) cured polymeric product, i.e. a rubber, is disposed in the step defined in the side wall.

A sealing ring unit having an elastomeric seal body is engaged with the casing. A pair of frustoconical surfaces, namely, an “air” side surface and an “oil” side surface meet along a generally circular locus to form a seal band. The elastomeric seal body also includes a spring groove for confining a garter spring adapted to provide or enhance a radial compressive load to be applied by the seal band to the outer diameter shaft surface to provide the “primary” seal, i.e., the seal between parts that move relative to each other.

The wear sleeve includes an annular wall or a shaft-engaging skirt portion extending to a radial flange. The inside diameter surface of the skirt portion is completely cylindrical and further extends to a neck portion with a diameter smaller than the inside diameter surface of the skirt portion thereby forming a step section. A shaft engaging seal element, i.e a second seal element formed from a liquid ultraviolet (UV) cured polymeric product, i.e. a rubber, is disposed in the step section. The shaft engaging seal snags in liquid-tight engagement with the outer diameter surface of the shaft.

A method of forming the seal assembly begins with placing a first metal blank in a first mold to form the cup of the casing unit. The sealing ring unit is then molded to the casing unit. The casing unit is then placed into a rotary UV applicator tooling nest (the tool) rotatable about the axis and exposed to UV curing polymeric material applied to the outer diameter (OD) defined by the first step. While the tool is rotated about the axis with the casing unit positioned therein, the UV curing polymeric material is cured by ultraviolet arrays, i.e. light.

A second metal blank is then placed into the tool rotatable about the axis and exposed to UV curing polymeric material applied to the inner diameter (ID) defined by the second step. While the tool is rotated about the axis, the UV curing polymeric material is cured by ultraviolet arrays, i.e. light. The spring is then assembled to the sealing ring unit. The casing unit with the first sealing element extending over the OD of the first step is then press fit into the housing. The wear sleeve with the second sealing element connected to the ID of the second step is press fit onto the shaft. The shaft and the housing are then assembled so that the sealing ring unit is riding and positioned in the proper location on the ID of the wear sleeve.

An advantage of the present invention is to provide an improved fluid seal assembly that eliminates problems associated with prior art designs such as static leakage of oil, clogging up the spirals with carbonized oil that negatively impact lifecycle of the fluid seals.

Another advantage of the present invention is to provide the fluid seal assembly that improves retention in metal bores during thermal expansion and eliminate spring back of the assembly after installation.

Still another advantage of the present invention is to provide the fluid seal assembly that is cost effective in manufacturing thereby allowing one shaft size compression or injection mold to make many different seals for the same shaft size, but many different bore sizes.

Still another advantage of the present invention is to provide the fluid seal assembly that replaces prior art designs of the fluid seals and provides an improved sealing solution that allows some resilience in order to improve retention of the seals in the bore during thermal cycles.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a cross sectional view of a seal assembly (the assembly) circumscribing a shaft and disposed between the shaft and a counter surface;

FIG. 2 illustrates a partial cross sectional view of a casing unit of the assembly presenting a step and a seal element bonded to the step;

FIG. 3 illustrates a partial cross sectional view of a wear sleeve presenting a step and a second seal element bonded to the step of the wear sleeve; and

FIG. 4 illustrates a diagram of the method of forming the assembly of the present invention.

### DETAILED DESCRIPTION OF THE INVENTION

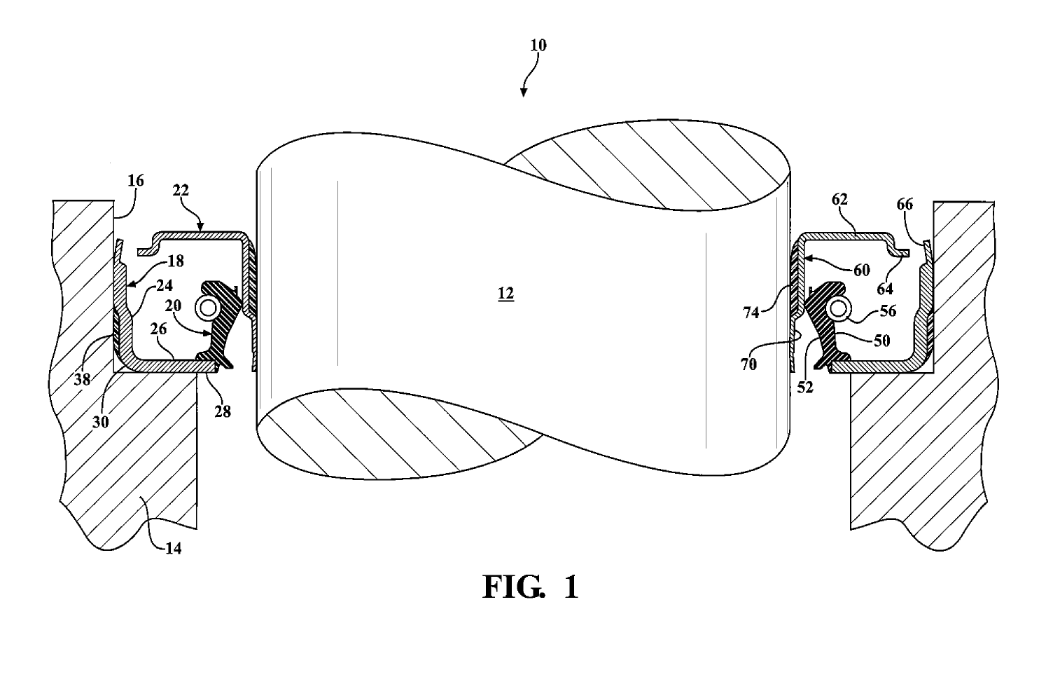

Referring to the Figure, wherein like numerals indicate like or corresponding parts throughout the several views, a fluid seal assembly (the assembly) of the present invention is generally shown at 10 FIGS. 1 through 3. The assembly 10 has numerous applications including and not limited to sealing vehicular engine crankshafts, transmission shafts, bearing lubrication systems, compressor shaft support assemblies, and the like, without limiting the scope of the present invention. FIG. 1, for example, illustrates an environment, wherein the assembly 10 is disposed between a counterpart, such as a shaft 12 and a housing, such as an engine wall 14 or a housing defining a counter bore 16. Those skilled in the mechanical art will appreciate that the shaft 12 and the engine wall 14 are shown for exemplary purposes only and are not intended to limit the scope of the present invention.

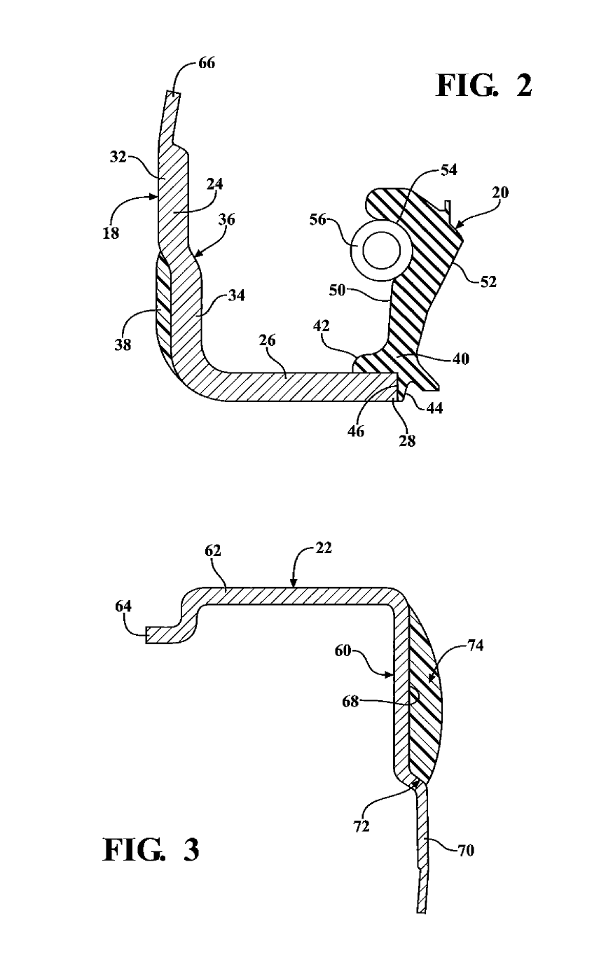

Referring back to FIGS. 1 and 2, a cross sectional view of the assembly 10 disposed between the engine wall 14 and the shaft 12 is shown. The assembly 10 includes a primary casing unit, generally indicated at 18, a sealing ring unit, generally indicated at 20, and a wear sleeve, generally indicated at 22. The casing unit 18 presents a rigid member having a side wall 24 presenting a bonding portion and a flange portion 26 extending outwardly from the side wall 24. The flange portion 26 terminates into a free end 28.

The flange portion 26 and the side wall 24 present a radius portion 30 defined therebetween. The flange portion 26 and the side wall 24 are formed by stamping of a metal blank defining a uniformed thickness, thereby forming the casing unit presenting the uniformed thickness, as shown in FIG. 1. The side wall 24 presents a first portion 32 and a second portion 34. The first portion 32 engages the counter bore 16, wherein the second portion 34 is spaced from the housing 14 by a first step, generally indicated at 36, thereby forming a void filled by a first sealing element, i.e. a first seal 38 bonded to the outer diameter of the second portion 34. The first seal 38 is formed from a liquid ultraviolet (UV) cured polymeric product, i.e. a rubber, is disposed in the step defined in the side wall. The first seal 38 is disposed in the void to improve retention of the casing unit 18 inside the housing 14 during thermal expansion and to eliminate spring back effect of the assembly 10 as the shaft 12 rotates relative the casing unit 18.

The sealing ring unit 20 is secured to the flange portion 26 of the casing unit 16 through a collar member 40. The collar member 40 includes a neck portion defined by an upper lip or inner bonding portion 42 and a lower lip or outer bonding portion 44 defining a nest 46 therebetween to sandwich the flange portion 26. The sealing ring unit 20 further includes a reverse surface 50 and an active surface 52.

A spring retention groove 54 is formed in the reserve surface 50 to retain a spring 56 thereby applying external pressure to the wear sleeve 22 circumscribing the shaft 12. The sealing ring unit 20 is formed from any suitable elastomeric materials, such as rubber, silicone, polyacrylic, fluoroelastomer, ethylene acrylic, hydrogenated nitrile or nitrile elastomer. The sealing ring unit 20 may also be formed from other materials such as, for example, polytetrafluoroethylene (PTFE) without limiting the scope of the present invention. The sealing ring unit 20 is injection molded but may be formed by many other suitable methods without limiting the scope of the present invention.

Referring to FIG. 3, a partial cross sectional view of the wear sleeve 22 is shown. The wear sleeve 22 is formed from a second blank of metal by stamping of this metal blank defining the wear sleeve 22 of substantially uniformed thickness. The wear sleeve 22 includes an annular wall or a shaft-engaging skirt portion, generally indicated at 60, extending to a radial flange 62 terminating to a distal end 64 formed to engage a terminal end 66 of the side wall 24 thereby defining a mechanical connection between the wear sleeve 22 and the primary casing unit 18. The inside diameter surface 68 of the skirt portion 60 is completely cylindrical and further extends to a neck portion 70 with a diameter smaller than the inside diameter surface 68 of the skirt portion thereby forming a step section or second step, generally indicated at 72.

Alluding to the above, a second shaft engaging seal element, i.e. a second seal is generally indicated at 74. The second seal 74 sits on the second step 72 and bonded to the inside diameter surface 68 of the skirt portion 60. The seal 74 snags in liquid-tight engagement with the outer diameter surface of the shaft 16. Similar to the first seal 38, the second seal 74 is formed from a liquid ultraviolet (UV) cured polymeric material, i.e. a rubber.

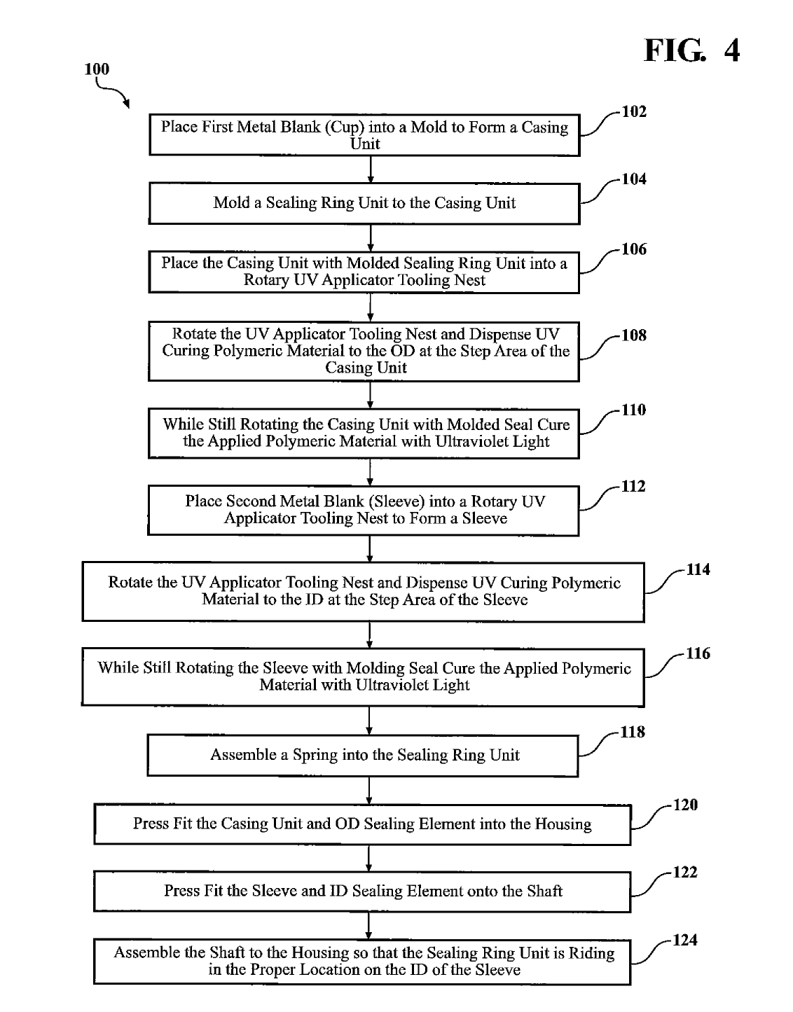

FIG. 4 illustrates a diagram of a method of forming the assembly 10, which is generally shown at 100. The method 100 of forming the seal assembly 10 begins with placing 102 a first metal blank in a first mold to form the cup of the casing unit 18. The sealing ring unit 20 is then molded 104 to the casing unit 18. The casing unit 18 is then placed 106 into a rotary UV applicator tooling nest (the tool). The tool is rotated 108 about the axis and exposed to the liquid ultraviolet (UV) cured polymeric material applied to the outer diameter (OD) defined by the first step 36. While the tool is rotated 110 about the axis with the casing unit 18 positioned therein, the UV curing polymeric material is cured by ultraviolet arrays, i.e. light.

A second metal blank is then placed 112 is also placed into a second mold to form the wear sleeve 22. The wear sleeve 22 is then placed 114 into the tool rotatable about the axis and exposed 116 to the liquid ultraviolet (UV) cured polymeric material applied to the inner diameter (ID) defined by the second step 72. The spring 50 is then assembled 118 to the sealing ring unit 20. The casing unit 18 with the first sealing element 38 extending over the OD of the first step 36 is then press fit 120 into the housing 14. The wear sleeve 22 with the second seal 74 connected to the ID of the second step 72 is press fit 122 onto the shaft 12. The shaft 12 and the housing 14 are then assembled 124 so that the sealing ring unit 20 is riding and positioned in the proper location on the ID of the wear sleeve 22.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A seal assembly for providing a seal between a housing and a cylindrical member rotatable around a central axis and relative the housing, said seal assembly comprising:
a casing unit defined by a side wall presenting a first step formed therein;
a sealing ring unit secured to said casing unit and presenting an active surface surrounding the cylindrical member;
a sleeve positioned between said sealing ring and the cylindrical member, said sleeve presenting a second step formed therein; and
a first sealing element disposed around and bonded said first step and sandwiched between the housing and said casing unit and a second sealing element disposed around and bonded to said second step and sandwiched between said sleeve and the cylindrical member thereby improving retention of said casing unit inside the housing during thermal expansion and eliminating spring back effect of said seal assembly as the cylindrical member rotates relative said casing unit.

2. A seal assembly as set forth in claim 1, wherein said first and second sealing elements are formed from at least one of elastomeric materials, such as silicone, polyacrylic, fluoroelastomer, ethylene acrylic, polytetrafluoroethylene cured by ultraviolet light.

3. A seal assembly as set forth in claim 1, wherein said side wall of said casing unit presents a first portion and a second portion with said first portion engaging the housing and said second portion being spaced from the housing by said first step thereby forming a void therebetween with said first sealing element filling disposed in the void to improve retention of said casing unit inside the housing during thermal expansion and eliminate spring back effect of said seal assembly as the cylindrical member rotates relative said casing unit.

4. A seal assembly as set forth in claim 1, wherein said casing unit includes a flange portion extending from said second portion of said side wall.

5. A seal assembly as set forth in claim 4, wherein said sealing ring unit includes a sleeve portion defining an active surface and a reverse surface.

6. A seal assembly as set forth in claim 1, wherein said sealing ring unit is formed from at least one of elastomeric materials, such as silicone, polyacrylic, fluoroelastomer, ethylene acrylic, polytetrafluoroethylene.

7. A seal assembly as set forth in claim 1, wherein said sleeve present a skirt portion extending to a neck portion presenting said second step between said skirt portion and said neck portion with said neck portion frictionally engaging the cylindrical member and said neck portion being spaced from the cylindrical member by said second step thereby forming an inner void therebetween with said second sealing element disposed in the inner void to improve retention of said casing unit inside the housing during thermal expansion and eliminate spring back effect of said seal assembly as the cylindrical member rotates relative said casing unit.

8. A seal assembly as set forth in claim 7, wherein said sleeve presents a radial flange extending from said skirt portion to connect with said side wall of said casing unit thereby forming said seal assembly.

9. A seal assembly as set forth in claim 10, wherein said sleeve portion presents a spring retention groove defined in said reversed surface to retain a spring.

10. A method of forming a seal assembly to provide a seal between a cylindrical member and a housing with the cylindrical member rotatable around a central axis and relative the housing, said method comprising the steps of:
placing a first metal blank into a first mold to form a casing unit to define a side wall presenting a first step stamped therein;
placing a second metal blank into a second mold to form a sleeve having a second step stamped therein;
placing the casing unit on a first spindle and placing the sleeve on a second spindle to rotate the first and second spindles; and
rotating the casing unit and the sleeve to apply a polymeric material onto and around the first step and the second step to cure the polymeric material with ultraviolet light thereby forming a first sealing element around the first step of the casing unit and a second sealing element around the second step of the sleeve to improve retention of the casing unit inside the housing during thermal expansion and to eliminate spring back effect of the seal assembly as the cylindrical member rotates relative the casing unit.

11. A method as set forth in claim 10, including the step of placing the casing unit into a rotary UV applicator tool rotated about an axis as the polymeric material is cured.

12. A method as set forth in claim 10, including the step placing the sleeve into the rotary UV applicator tool rotatable about the axis as the polymeric material is cured.

13. A method as set forth in claim 10, wherein the step of forming the first element and the second element is further defined by forming the first and second elements from at least one of elastomeric materials, such as silicone, polyacrylic, fluoroelastomer, ethylene acrylic, polytetrafluoroethylene cured by ultraviolet light.

14. A method as set forth in claim 10, including the step of forming a flange portion extending from the second portion of the side wall.

15. A method as set forth in claim 10, including the step of forming a sleeve portion defining an active surface and a reverse surface.

16. A method as set forth in claim 10, wherein the step of forming the sleeve portion is further defined by forming the sleeve portion from at least one of elastomeric materials, such as silicone, polyacrylic, fluoroelastomer, ethylene acrylic, polytetrafluoroethylene.

17. A method as set forth in claim 10, wherein the step of forming the sleeve is further defined by forming a skirt portion extending to a neck portion presenting the second step between said body portion and said neck portion.

18. A method as set forth in claim 10, wherein the step of forming the side wall of the casing unit is further defined by forming a first portion and a second portion of the side wall spaced from the housing by the first step.

19. A method as set forth in claim 10, including the step of press fitting the casing unit onto the housing.

20. A method as set forth in claim 10, including the step of press fitting the sleeve onto the shaft.
